(19) United States
(12) Patent Application Publication
(10) Pub. No.: US 2010/0192834 A1
(43) Pub. Date: Aug. 5, 2010

(54) Aircraft safety system

(76) Inventor: Max Fogiel Fogiel, New York, NY (US)

Correspondence Address: Max Fogiel, 11 Riverside Drive, New York, NY, 10023, US

(21) Appl. No.: 12/320,674

(22) Filed: Feb. 2, 2009

(51) Int. Cl. A01M 29/00

(52) U.S. Cl. 116/22 A

(57) ABSTRACT

A tone or sound transmitter located on aircraft engines for emitting sounds found unpleasant to birds so as to scare them and preventing them thereby from entering the interiors of aircraft engines and preventing malfunctioning or crashing of the aircraft.

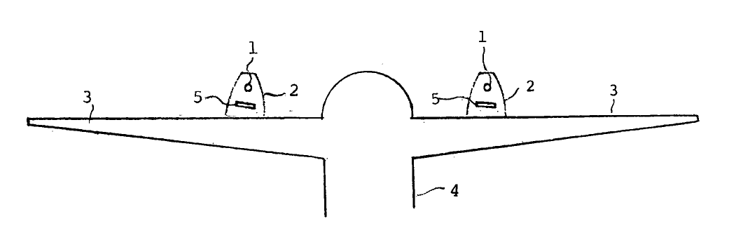

### DETAILED DESCRIPTION OF THE INVENTION

To scare off birds, fowl, or other live animals and prevent them from entering the interios of aircraft engines, tone transmitters 1 are placed or located on engines 2 held on wings 3 of aircraft 4. The tone transmitters 1 emit sounds which serve to scare off birds, fowl and other live creatures.

The tone transmitters 1 emit sounds which serve to scare off birds, fowl and other live creatures. The sounds emitted can be of a single frequency or a mixture of frequencies that are found unpleasant to birds and other live creatures, and thereby prevent them from entering the aircraft engines. The tone transmitters 1 can be operated preferably before and also after takeoff of the aircraft. The sounds can be emitted in continuous waveform or one that has a pattern of interruptions at intervals.

The frequency or frequencies emitted by the tone transmitters can be adjusted or changed by the frequency control unit 5. This control unit may be in the form of an Oscillator in which the frequency signal can be varied or adjusted to what different live creatures find unpleasant and are thereby scared off from entering the engines.

The emitted sounds found to deter animal life, furthermore, may or may not be detectable by human ears.

The emitted sounds adjusted by the control unit 5, can be in the form of a single frequency, multiple or mixture of frequencies, a continuous waveform, a sound emitted in spurts, a sound with interruptions at intervals, sound that is inaudible to humans, and sound emitted before and/or after takeoff of the aircraft.

The invention claimed is:

1. An aircraft with at least one engine for providing power for takeoff and lifting the aircraft into the air; means on the aircraft for holding said engine; and sound transmitting means on said engine for emitting sound to deter animals from entering the engine.

2. An aircraft as defined in claim 1, wherein said sound is of a single rrquency.

3. An aircraft as defined in claim 1, wherein said sound if of multiple frequencies.

4. An aircraft as defined in claim 1, wherein said sound is unpleasant to animals.

5. An aircraft as defined in claim 1, wherein said sound is a mixture of frequencies.

6. An aircraft as defined in claim 1, wherein said sound is in a continuous waveform.

7. An aircraft as defined in claim 1, wherein said sound is emitted in spurts.

8. An aircraft as defined in claim 1, wherein said sound is inaudible to humans.

9. An aircraft as defined in claim 1, wherein said sound has interruptions at intervals.

10. An aircraft as defined in claim 1, wherein said sound is emitted after takeoff of the aircraft.

11. An aircraft as defined in claim 1, wherein said sound is emitted before takeoff of the aircraft.
